(19) United States
(12) Patent Application Publication
(10) Pub. No.: US 2003/0042996 A1
(43) Pub. Date: Mar. 6, 2003

(54) Dielectric duplexer

(76) Inventors: Shoji Ono, Ise (JP); Hidefumi Suzuki, Ise (JP); Yukihiro Hamaguchi, Watarai-gun (JP)

Correspondence Address: LARSON & TAYLOR, PLC, 1199 NORTH FAIRFAX STREET, SUITE 900, ALEXANDRIA, VA, 22314, US

(21) Appl. No.: 10/235,657

(22) Filed: Sep. 6, 2002

(30) Foreign Application Priority Data
Sep. 6, 2001 (JP) 2001-270616

(51) Int. Cl. H01P 5/12

(52) U.S. Cl. 333/134

(57) ABSTRACT

A dielectric duplexer device is provided with an output terminal pad formed on a side surface of a dielectric block in the vicinity of an open end associated with a plurality of resonators of a reception section in such a manner as to face the resonators. An extension electrode extends from the output terminal pad onto an end face of the dielectric block where the open end is present, to thereby be capacitively coupled with the resonators. The coupling capacitance can be readily corrected by adjusting the position of the end of the extension electrode. In one specific form, when the dielectric duplexer is mounted, the extension electrode is exposed and is also joined to a predetermined conductive path by means of solder. Accordingly, the output terminal pad is soldered at the bottom and side surfaces thereof to thereby be fillet-soldered, thereby providing visibility of electrical and mechanical connections thereof to the predetermined conductive path and thus enhancing the reliability of the mounted state.

### FIELD OF THE INVENTION

The present invention relates to a dielectric duplexer having a plurality of resonators arranged in a row for use in mobile communication devices such as car phones and cellular phones.

### BACKGROUND OF THE INVENTION

Various prior art dielectric duplexer devices are configured in the form of a plurality of resonators arranged in a row in a dielectric ceramic porcelain block material such as porcelain. Each of the resonators is formed by coating the internal circumferential surface of a through-hole formed in the dielectric porcelain block with an internal conductor. A predetermined external circumferential surface of the dielectric porcelain block is coated with an external conductor. The resonators comprise two groups. One group serves as a transmission section, which is coupled with an input terminal pad formed on the predetermined external circumferential surface, separated from the external conductor. The other group serves as a reception section, which is coupled with an output terminal pad formed on the predetermined external circumferential surface, separated from the external conductor. An antenna terminal pad is formed on a mounting surface of the dielectric duplexer, separated from the external conductor in such a manner as to be coupled with the respective resonators of the transmission section and of the reception section located closest to one another in the row.

A further prior art dielectric duplexer device is configured as above but also includes an output terminal pad formed on a side surface of the dielectric porcelain block in order to face the resonators of the reception section in the vicinity of their open ends, whereby the output terminal pad is capacitively coupled with the resonators.

The above-mentioned dielectric duplexer device, i.e., the device with the output terminal pad formed on the side surface of the dielectric porcelain block while being capacitively coupled with the resonators of the reception section, involves the following problem. The dielectric duplexer is mounted on a printed circuit board such that the output terminal pad is electrically joined to a predetermined conductive path on the board through soldering. Since the state of a joint between the conductive path and the output terminal pad cannot be visually observed from the outside, the joint involves uncertainty as to electrical and mechanical connection and thus always falls under suspicion when a defect arises at a later stage. Further, since the connected state is invisible, the retention strength cannot be reliably known. Therefore, a dielectric duplexer of conventional configuration fails to provide sufficient electrical and mechanical reliability in a mounted state.

### SUMMARY OF THE INVENTION

The present invention concerns a dielectric duplexer which has improved electrical and mechanical reliability in a mounted state and which facilitates adjustment of the coupling capacitance provided.

The present invention concerns a dielectric duplexer configured such that a plurality of resonators are arranged in a row in a dielectric material such as porcelain block. Each of the resonators are formed through coating an internal circumferential surface of a through-hole formed in the dielectric block with an internal conductor. A predetermined external circumferential surface of the dielectric porcelain block is coated with an external conductor. The resonators are divided into two groups. One group serves as a transmission section, which is coupled with an input terminal pad formed on the predetermined external circumferential surface, separated from the external conductor. The other group serves as a reception section, which is coupled with an output terminal pad formed on the predetermined external circumferential surface, separated from the external conductor. An antenna terminal pad is formed on a mounting surface of the dielectric duplexer separated from the external conductor in such a manner as to be coupled with the innermost resonator of the transmission section and the innermost resonator of the reception section.

In accordance with an important feature of the invention, the dielectric duplexer includes the output terminal pad formed on a side surface of the dielectric block and separated from the external conductor in such a manner as to face the vicinity of an open end of a resonator of the reception section. In addition, an extension electrode extends from the output terminal pad onto an end face of the dielectric block such that the extension electrode approaches the open end in order to capacitively couple with the resonator.

Since the extension electrode extending from the output terminal pad and located on the open end face is disposed to face the resonators of the reception section, a capacitance is provided between the extension electrode and the internal conductor of the resonator. This capacitance can be readily corrected or adjusted by adjusting the position of the end of the extension electrode. The end position is adjusted by, for example, cutting off a portion of the end or adding a conductor to the end.

When the dielectric duplexer is mounted on a printed circuit board such that the output terminal pad is electrically joined to a predetermined conductive path on the board through soldering, the extension electrode located on an exposed surface of the dielectric duplexer can be soldered to the predetermined conductive path from the outside. Thus, the output terminal pad is soldered at the bottom and side surfaces thereof, i.e., the output terminal pad is fillet-soldered. Therefore, the connection between the output terminal pad and the predetermined conductive path can be checked externally. Further, since the extension electrode is connected to the predetermined conductive path, the surface of joint is expanded, thereby enhancing the retention strength thereof.

Further features and advantages of the present invention will be set forth in, or apparent from, the detailed description of preferred embodiments thereof which follows.

### BRIEF DESCRIPTION OF THE DRAWINGS

FIG. 1 is a perspective view of a dielectric duplexer according to an embodiment of the present invention;

FIG. 2 is a top plan view of the dielectric duplexer of FIG. 1;

FIG. 3 is a bottom plan view of the dielectric duplexer of FIG. 1; and

FIG. 4 is a sectional fragmentary view showing the mounted dielectric duplexer of FIG. 1.

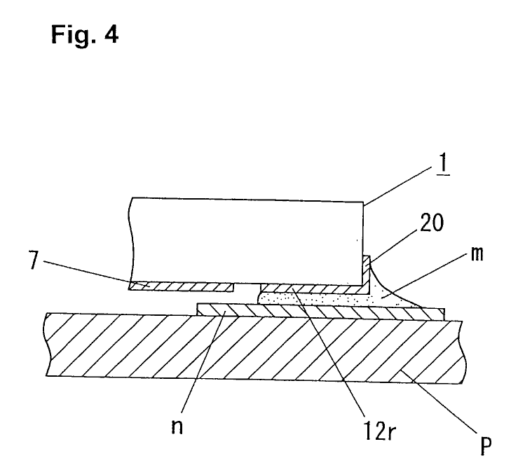

### DESCRIPTION OF THE PREFERRED EMBODIMENTS

An embodiment of the present invention will now be described with reference to the accompanying drawings.

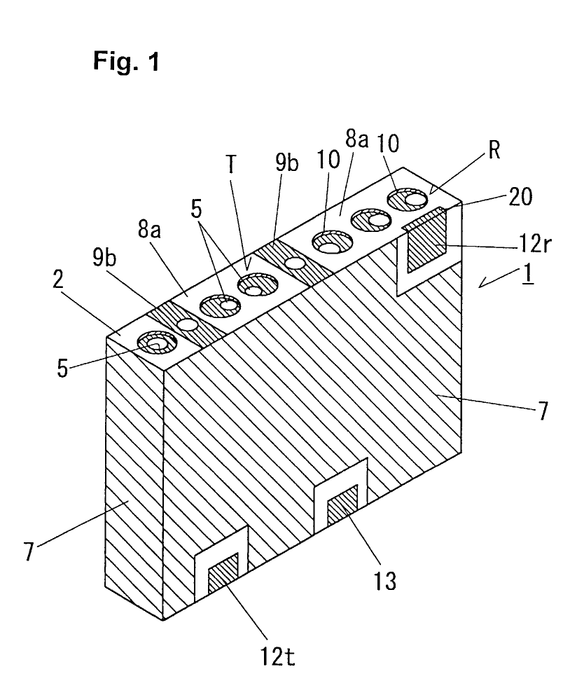

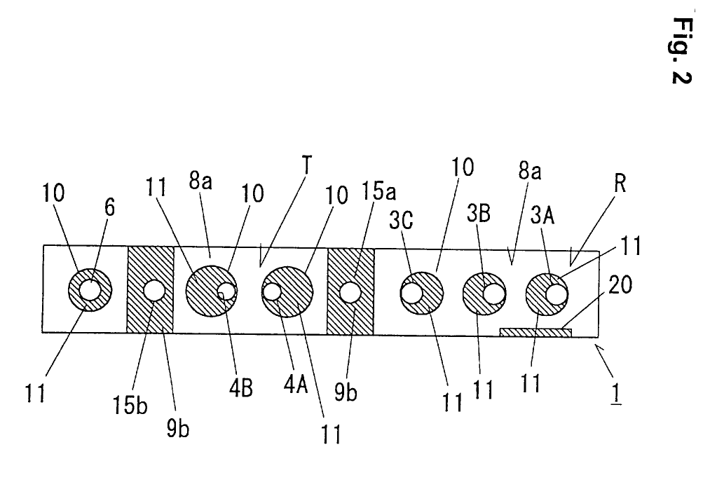

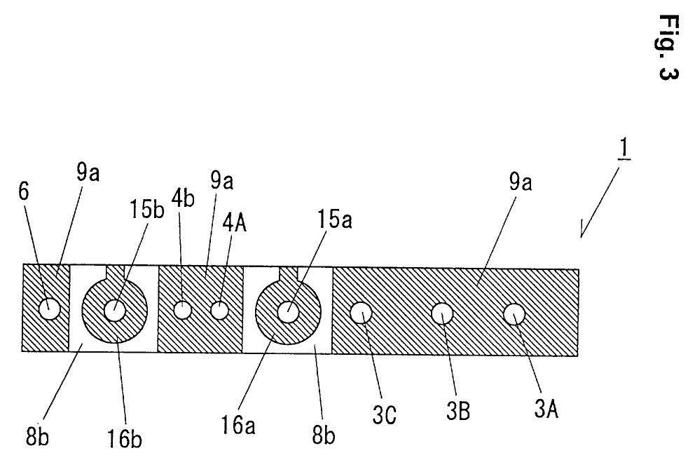

FIGS. 1 to 3 show a dielectric duplexer 1 in which eight through-holes 5 each coated with an internal conductor are formed in a dielectric ceramic block 2 of, for example, porcelain and having a flat, rectangular parallelepiped shape. Referring to FIG. 2, the through-holes 5 are described from the right: the three rightmost through-holes 5 serve as reception resonators 3A-3C; the fourth through-hole 5 serves as an antenna excitation hole 15a; the subsequent two through-holes 5 serve as transmission resonators 4A and 4B; the seventh through-hole 5 serves as a transmission excitation hole 15b; and the leftmost through-hole 5 serves as a trap formation resonator 6. The through-holes 5 are grouped in this manner, whereby the dielectric duplexer 1 is configured such that a group consisting of the three resonators 3A, 3B, and 3C serves as a three-pole-type reception section R, whereas a group consisting of the two resonators 4A and 4B serves as a two-pole-type transmission section T. The resonators 3A-3C, 4A, 4B, and 6 substantially assume a length corresponding to λ/4, where λ is a wavelength corresponding to the predetermined resonant frequency. The dielectric porcelain block 2 is coated with an external conductor 7 on a predetermined outer circumferential surface thereof. The external conductor 7 serves as a shield electrode.

The resonators 3A-3C, 4A, 4B, and 6 are arranged in a row in the dielectric porcelain block 2. A portion of one end face of the dielectric porcelain block 2 serves as an open end 8a, where the external conductor 7 is absent, associated with the resonators, whereas a portion of the opposite end face of the dielectric porcelain block 2 serves as a short circuit end 9a associated with the resonators.

The antenna excitation hole 15a and the transmission excitation hole 15b assume an interdigital structure in relation to the resonators. Specifically, an open end 8b and a short circuit end 9b associated with the excitation holes 15a and 15b are located opposite the open end 8a and the short circuit end 9a associated with the resonators.

Annular counterbores 10 for coupling adjacent resonators are formed on the open end 8a associated with the resonators 3A-3C, 4A, 4B, and 6 around the corresponding openings. An extension conductor 11 is formed on the bottom surface of each of the counterbores 10 and is connected to the corresponding internal conductor. An interval between the counterbores 10 is defined as an interval between resonators. A coupling capacitance of the resonators can be determined by means of the position, size, and shape of the counterbores 10.

An antenna terminal pad 13 is formed, separated from the external conductor 7, on a side surface of the dielectric porcelain block 2 in the vicinity of the open end 8b associated with the antenna excitation hole 15a, and is connected to the excitation hole 15a via a connection conductor 16a. In this manner, the antenna terminal pad 13 is coupled via the excitation hole 15a with the respective resonators 3C and 4A of the reception section R and the transmission section T located closest to one another in the row.

Similarly, an input terminal pad 12t is formed, separated from the external conductor 7, on a side surface of the dielectric porcelain block 2 in the vicinity of the open end 8b associated with the transmission excitation hole 15b, and is connected to the excitation hole 15b via a connection conductor 16b. In this manner, the input terminal pad 12t is coupled with the transmission section T via the excitation hole 15b.

The output terminal pad 12r of the reception section R is formed on the mounting surface of the dielectric duplexer 1 separated from the external conductor 7 while the greatest possible distance is established from the above-described antenna terminal pad 13. Specifically, the output terminal pad 12r is formed separated from the external conductor 7 in the vicinity of the open end 8a, which is located on the side opposite the open end 8b, while facing the resonators 3A and 3B located at the endmost position of the reception section R. In this manner, the output terminal pad 12r is capacitively coupled with the reception section R.

In the embodiment shown in FIG. 2, an extension electrode 20 is extended from the output terminal pad 12r onto an end face of the dielectric porcelain block 2 where the open end 8a is located, to thereby be capacitively coupled with the resonators 3A and 3B. Formation of the extension electrode 20 in opposition to the resonators 3A and 3B of the reception section R generates capacitance between the extension electrode 20 and the internal electrodes of the resonators 3A and 3B. This capacitance can be readily corrected by adjusting the position of the end of the extension electrode 20. Specifically, when the capacitance is excessive, the end is cut off or otherwise reduced in size. When the capacitance is insufficient, a conductor is added to the end. Since the extension electrode 20 is exposed, this adjustment can be performed even after the dielectric duplexer 1 is mounted on a printed circuit board p, thereby facilitating matching with peripheral devices.

The dielectric duplexer 1 is mounted on the printed circuit board p such that the input terminal pad 12t, the output terminal pad 12r, and the antenna terminal 13 are electrically and mechanically soldered to corresponding predetermined conductive paths n on a circuit of the printed circuit board p by means of a solder m. In this case, the input terminal pad 12t is connected to the transmission excitation hole 15b via the connection conductor 16b, and the antenna terminal 13 is connected to the antenna excitation hole 15a via the connection conductor 16a. Thus, when the dielectric duplexer 1 is mounted on the printed circuit board p, the connection inductors 16a and 16b-which are located on an end face of the dielectric porcelain block 2 where the corresponding open ends 8b associated with the excitation holes 15a and 15b are present-are exposed, and the rectangular ends of the connection conductors 16a and 16b are also soldered to the corresponding predetermined conductive paths n by means of the solder m. Thus, the input terminal pad 12t and the antenna terminal 13 are soldered at the bottom and side surfaces thereof via the connection conductors 16b and 16a, respectively, i.e., each of the input terminal pad 12t and the antenna terminal 13 is fillet-soldered, thereby ensuring electrical and mechanical connections thereof and enabling visibility of the state of connection thereof from the outside.

As described above, the extension electrode 20 extending from the output terminal pad 12r is located on an end face of the dielectric porcelain block 2 while facing the resonators 3A and 3B of the reception section R. Therefore, when the dielectric duplexer 1 is mounted on the printed circuit board p, the extension electrode 20—which is located on the end face of the block 2 where the open end 8a associated with the resonators 3A and 3B is present-is exposed. Thus, the exposed extension electrode 20 is also soldered to a predetermined conductive path n by means of the solder m. Accordingly, the output terminal pad 12r is soldered at the bottom and side surfaces thereof; i.e., the output terminal pad 12r is fillet-soldered, thereby ensuring electrical and mechanical connections thereof to the predetermined conductive path n and enabling visibility of the state of connection thereof from the outside.

Since the extension electrode 20 extends from the output terminal pad 12r onto an end face of the dielectric porcelain block where the open end 8a is present, the connection between the output terminal pad 12r and the predetermined conductive path n can be checked from the outside. Further, since the extension electrode 20 is also connected to the predetermined conductive path n, the surface of joint is expanded, thereby enhancing retention strength. Additionally, the input terminal pad 12t, the antenna terminal 13, and the output terminal pad 12r are soldered at the bottom and side surfaces thereof via the connection conductors 16b and 16a and the extension electrode 20, respectively; i.e., each of the input terminal pad 12t, the antenna terminal 13, and the output terminal pad 12r is fillet-soldered. Therefore, the dielectric duplexer 1 as a whole can be enhanced in terms of electrical and mechanical connections, and the state of electrical and mechanical connections can be visually checked, thereby enhancing the reliability of the mounted state of the duplexer.

One of ordinary skill in the art will readily appreciate that the number of resonators to be employed may be varied as appropriate to implement a multiple-type dielectric duplexer.

The present dielectric duplexer is configured such that the output terminal pad is formed on a side surface of the dielectric porcelain block separated from the external conductor in such a manner as to face the vicinity of an open end of a resonator of the reception section, and an extension electrode is extended from the output terminal pad onto an end face of the dielectric porcelain block such that the extension electrode approaches the open end in order to capacitively couple with the resonator, thereby yielding the following effects:

The coupling capacitance can be readily corrected by adjusting the position of the end of the extension electrode. Further, this adjustment can be performed even after the dielectric duplexer is mounted.

When the dielectric duplexer is mounted, the extension electrode is exposed and is also joined to a predetermined conductive path by means of solder. Accordingly, the output terminal pad is soldered at the bottom and side surfaces thereof to thereby be fillet-soldered, thus enabling viewing of the electrical and mechanical connections thereof to the predetermined conductive path and, as a consequence, enhancing the reliability of the mounted state of the duplexer.

Finally, since the extension electrode allows fillet soldering, the mechanical joining strength can be enhanced, thereby enhancing the retention strength.

Although the invention has been described above in relation to preferred embodiments thereof, it will be understood by those skilled in the art that variations and modifications can be effected in these preferred embodiments without departing from the scope and spirit of the invention.

What is claimed:

1. A dielectric duplexer comprising:
a dielectric block having a plurality of resonators arranged in a row; each of said resonators being formed through coating an internal circumferential surface of a through-hole formed in said dielectric block with an internal conductor;
a predetermined external circumferential surface of said dielectric block being coated with an external conductor;
said resonators comprising a first group and a second group, said first group serving as a transmission section, and said transmission section being coupled with an input terminal pad formed on said predetermined external circumferential surface separated from said external conductor, said second group serving as a reception section, and said reception section being coupled with an output terminal pad formed on said predetermined external circumferential surface separated from said external conductor; and
an antenna terminal pad formed on a mounting surface of said dielectric duplexer separated from said external conductor in such a manner as to be coupled with said transmission section and said reception section,
said output terminal pad being formed on a side surface of said dielectric block in such a manner as to face the vicinity of an open end of one of said resonators of said reception section, and said duplexer further comprising an extension electrode extending from said output terminal pad onto an end face of said dielectric block such that said extension electrode approaches the open end in order to capacitively couple with said one resonator of said reception section.

2. The dielectric duplexer according to claim 1, further comprising a transmission excitation through-hole formed in said dielectric block at a position located to one side of said first group of resonators opposite to said second group of resonators, said input terminal pad being formed on a side surface of said dielectric block in such a manner as to face the vicinity of an open end of the transmission excitation through-hole, and being connected to the transmission excitation through-hole via a connection conductor formed on an end face of said dielectric block where said open end is located whereby said input terminal pad is coupled with said transmission section via said transmission excitation though-hole.

3. The dielectric duplexer according to claim 2, wherein said end face at which said open end of said transmission excitation through-hole is located is opposite the end face onto which said extension electrode is extended.

4. The dielectric duplexer according to claim 2, wherein said input terminal pad is formed on the same side surface of said dielectric block as said output terminal pad.

5. The dielectric duplexer according to claim 1, further comprising an antenna excitation through-hole formed in said dielectric block at a position between said first group of resonators and said second group of resonators, said antenna terminal pad being formed on a side surface of said dielectric block in such a manner as to face the vicinity of an open end of the antenna excitation through-hole, and being connected to the antenna excitation through-hole via a connection conductor formed on an end face of said dielectric block where said open end is located, whereby said antenna terminal pad is coupled with both said reception section and said transmission section via the antenna excitation through-hole.

6. The dielectric duplexer according to claim 5, wherein said end face at which said open end of said antenna excitation through-hole is located is opposite the end face onto which said extension electrode is extended.

7. The dielectric duplexer according to claim 5, wherein said antenna terminal pad is formed on the same side surface of said dielectric block as said output terminal pad.

8. The dielectric duplexer according to claim 1, wherein said antenna terminal pad is coupled with respective resonators of said transmission and reception sections located closest to one another in said row.

9. The dielectric duplexer according to claim 1, wherein a counterbore is formed in the dielectric block at an open end of each resonator of said transmission and reception sections.

10. The dielectric duplexer according to claim 9, wherein said open ends of said resonators of said transmission and reception sections are all located at the same said end face of said dielectric block.

11. The dielectric duplexer according to claim 1, wherein said dielectric block is made of porcelain.

12. An assembly comprising:
a printed circuit board including a conductor formed on a surface thereof; and
a dielectric duplexer comprising:
a dielectric block having a plurality of resonators arranged in a row; each of said resonators being formed through coating an internal circumferential surface of a through-hole formed in said dielectric block with an internal conductor;
a predetermined external circumferential surface of said dielectric block being coated with an external conductor;
said resonators comprising a first group and a second group, said first group serving as a transmission section, and said transmission section being coupled with an input terminal pad formed on said predetermined external circumferential surface separated from said external conductor, said second group serving as a reception section, and said reception section being coupled with an output terminal pad formed on said predetermined external circumferential surface separated from said external conductor; and
an antenna terminal pad formed on a mounting surface of said dielectric duplexer separated from said external conductor in such a manner as to be coupled with said transmission section and said reception section,
said output terminal pad being formed on a side surface of said dielectric block in such a manner as to face the vicinity of an open end of one of said resonators of said reception section, and said duplexer further comprising an extension electrode extends from said output terminal pad onto an end face of said dielectric block such that said extension electrode approaches the open end in order to capacitively couple with said resonator of said one reception section;
said dielectric duplexer being mounted on said surface of said printed circuit board with said output terminal pad facing, and being electrically connected by a solder connection to, said conductor, said end face and said extension electrode thereon being exposed, and said extension electrode being soldered by said solder connection to said conductor.
